(19) United States
(12) Patent Application Publication
(10) Pub. No.: US 2015/0199718 A1
(43) Pub. Date: Jul. 16, 2015

(54) SELECTING CONTENT ITEMS USING ENTITIES OF SEARCH RESULTS

(71) Applicant: Google Inc., Mountain View, CA (US)

(72) Inventors: Hannu Helminen, Zurich (CH); Ian James Leader, Zurich (CH)

(73) Assignee: Google Inc., Mountain View, CA (US)

(21) Appl. No.: 14/154,792

(22) Filed: Jan. 14, 2014

(51) Int. Cl. G06Q 30/02; G06F 17/30

(52) U.S. Cl. CPC G06Q 30/0256; G06F 17/30867

(57) ABSTRACT

Methods, systems, and apparatus include computer programs encoded on a computer-readable storage medium, including a method for providing content. Search results are identified for a received search query, including identifying a number of top search results. For each of the number of top search results, an associated page is evaluated to identify prominent entities that describe content represented by the page, wherein evaluating includes creating a list of prominent entities from each page. Selection criteria are determined using the list of prominent entities, including ranking the entities in the list of prominent entities based at least in part on importance of a given entity to a respective source page and a ranking of the source page, wherein determining includes determining a weighted list of entities to use as selection criteria. Using the selection criteria, one or more content items are determined to deliver along with the search results.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or the relevance of the sponsored content to content presented on a page hosting the slot or a request that is received for the sponsored content. The content can be provided to a user device such as a personal computer (PC), a smartphone, a laptop computer, a tablet computer, or some other user device.

### SUMMARY

In general, one innovative aspect of the subject matter described in this specification can be implemented in methods that include a computer-implemented method for providing content. The method includes receiving a search query. The method further includes identifying search results for the search query including identifying a number of top search results. The method further includes evaluating, for each of the number of top search results, an associated page to identify prominent entities that describe content represented by the page, wherein evaluating includes creating a list of prominent entities from each page. The method further includes determining selection criteria using the list of prominent entities including ranking the entities in the list of prominent entities based at least in part on importance of a given entity to a respective source page and a ranking of the source page, wherein determining includes determining a weighted list of entities to use as selection criteria. The method further includes determining one or more content items to deliver along with the search results using the selection criteria.

These and other implementations can each optionally include one or more of the following features. At least one entity in the weighted list of entities can represent an answer to the search query. The ranking can be based at least in part on a page rank of the source page in the search results. The ranking can be based at least in part on a popularity of the source page. An entity can be a concept mentioned on a web page. Identifying prominent entities can include annotating the page with entities including identifying entities on the page, disambiguating entities using other entities on the page and scoring the entities for the page to identify the prominent entities. The method can further include receiving, from content sponsors, campaign selection criteria for a given campaign, the campaign having an associated content item, wherein the campaign selection criteria are of the form of a list of entities to use when determining when to serve the content item, wherein determining one or more content items includes determining campaigns that have campaign selection criteria that match the selection criteria and serving one or more content items from the determined campaigns as the one or more content items.

In general, another innovative aspect of the subject matter described in this specification can be implemented in methods that include another computer-implemented method for providing creatives. The method includes presenting a user interface to a content sponsor that includes one or more controls for providing input related to selection criteria for use in a campaign. The method further includes receiving, based on interaction with the one or more controls, user input that specifies initial criteria. The method further includes evaluating the initial criteria to determine one or more entities that are associated with the initial criteria. The method further includes using the determined one or more entities as the selection criteria for the campaign.

These and other implementations can each optionally include one or more of the following features. The initial criteria can be a search query, and evaluating the initial criteria can further include determining search results responsive to the search query, determining entities based on the determined search results, and using the determined entities as the one or more entities. The initial criteria can include the designation of one or more web pages, wherein evaluating the initial criteria further includes evaluating the one or more web pages including determining entities associated with the one or more web pages and using the determined entities as the one or more entities. The one or more web pages can be target web pages that the content sponsor designates as being a type of page that, when presented as a search result, would represent a desirable opportunity to present a content item associated with the campaign from the perspective of the content sponsor. The one or more pages can be controlled by the content sponsor. The one or more pages can be landing pages associated with the campaign. The initial input can be a campaign designator that identifies a campaign associated with the content sponsor, and evaluating the initial criteria can further include determining a list of search queries that have matched the identified campaign, determining search results associated with one or more of the search queries, determining entities based on the determined search results, and using the determined entities as the one or more entities. An entity can be a concept mentioned on a web page.

In general, another innovative aspect of the subject matter described in this specification can be implemented in systems, including a system comprising one or more processors and one or more memory elements including instructions. The instructions, when executed, cause the one or more processors to: receive a search query; identify search results for the search query including identifying a number of top search results; evaluate, for each of the number of top search results, an associated page to identify prominent entities that describe content represented by the page, wherein evaluating includes creating a list of prominent entities from each page; determine selection criteria using the list of prominent entities including ranking the entities in the list of prominent entities based at least in part on importance of a given entity to a respective source page and a ranking of the source page, wherein determining includes determining a weighted list of entities to use as selection criteria; and determine one or more content items to deliver along with the search results using the selection criteria.

In general, another innovative aspect of the subject matter described in this specification can be implemented in computer program products that include a computer program product tangibly embodied in a computer-readable storage device and comprising instructions. The instructions, when executed by one or more processors, cause the processor to: receive a search query; identify search results for the search query including identifying a number of top search results; evaluate, for each of the number of top search results, an associated page to identify prominent entities that describe content represented by the page, wherein evaluating includes creating a list of prominent entities from each page; determine selection criteria using the list of prominent entities including ranking the entities in the list of prominent entities based at least in part on importance of a given entity to a respective source page and a ranking of the source page, wherein determining includes determining a weighted list of entities to use as selection criteria; and determine one or more content items to deliver along with the search results using the selection criteria.

In general, another innovative aspect of the subject matter described in this specification can be implemented in systems, including a system comprising one or more processors and one or more memory elements including instructions. The instructions, when executed, cause the one or more processors to: present a user interface to a content sponsor that includes one or more controls for providing input related to selection criteria for use in a campaign; receive, based on interaction with the one or more controls, user input that specifies initial criteria; evaluate the initial criteria to determine one or more entities that are associated with the initial criteria; and use the determined one or more entities as the selection criteria for the campaign.

In general, another innovative aspect of the subject matter described in this specification can be implemented in computer program products that include a computer program product tangibly embodied in a computer-readable storage device and comprising instructions. The instructions, when executed by one or more processors, cause the processor to: present a user interface to a content sponsor that includes one or more controls for providing input related to selection criteria for use in a campaign; receive, based on interaction with the one or more controls, user input that specifies initial criteria; evaluate the initial criteria to determine one or more entities that are associated with the initial criteria; and use the determined one or more entities as the selection criteria for the campaign.

Particular implementations may realize none, one or more of the following advantages. Content sponsors can specify that their content items (e.g., advertisements) are to be selected and presented based, at least in part, on entities associated with search results matching a user's search query. Content items that may be disregarded based on keywords alone (and/or other conventional criteria) can be selected for presentation if they are associated with entities identified from web pages associated with top search results matching a search query. Content sponsors can configure campaigns for their content items to include, in their selection criteria, entities that represent answers to queries rather than to terms of queries that are more geared to the questions (e.g., query terms) for identifying the entities.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2A shows an example system for selecting content items based on entities determined from search results.

FIG. 2B shows an example system for specifying entity-related parameters for use in a campaign.

FIG. 3A is a flowchart of an example process for selecting content items based on entities determined from search results.

FIG. 3B is a flowchart of an example process for specifying entity-related parameters for use in a campaign.

FIG. 4 is a block diagram of an example computer system that can be used to implement the methods, systems and processes described in this disclosure.

Like reference numbers and designations in the various drawings indicate like elements.

### DETAILED DESCRIPTION

This document describes systems, methods, computer program products and mechanisms for selecting content based on entities identified from search results. For example, a content sponsor can use a content sponsor user interface to specify that entities identified from search results are to be used for content selection in their campaigns. The user interface can include, for example, one or more controls for providing input related to selection criteria for use in a campaign. Based on content sponsor interaction with the one or more controls, user input can be received that specifies criteria, e.g., for use in identifying the entities to be used in the campaign. The content sponsor user interface can evaluate the criteria to determine one or more entities that are associated with the criteria. The determined one or more entities can be stored for the campaign.

Once content sponsors have designated that entities are to be used for content selection, for example, content items selected on the basis of entities can be provided to users who request and receive search results in response to queries. For example, based on a received search query, search results can be identified in response to the search query. Identifying the search results can also include identifying a predetermined number of search results (e.g., based on a likelihood of being viewed by the user), including a number of top search results. For each page of the number of top search results, an associated page can be evaluated to identify prominent entities that describe content represented by the page. The evaluating can include creating a list of prominent entities from each page. Selection criteria can be determined using the list of prominent entities. Ranking the entities in the list of prominent entities can be performed, for example, based at least in part on an importance of a given entity to a respective source page and a ranking of the source page. A weighted list of entities to use as selection criteria can also be determined. Using the selection criteria, one or more content items can be selected for delivery along with the search results. For example, advertisements can be selected, at least in part, on the basis of entities that are associated with (or appear in) search results. Other ways of selecting and presenting content associated with entities are possible.

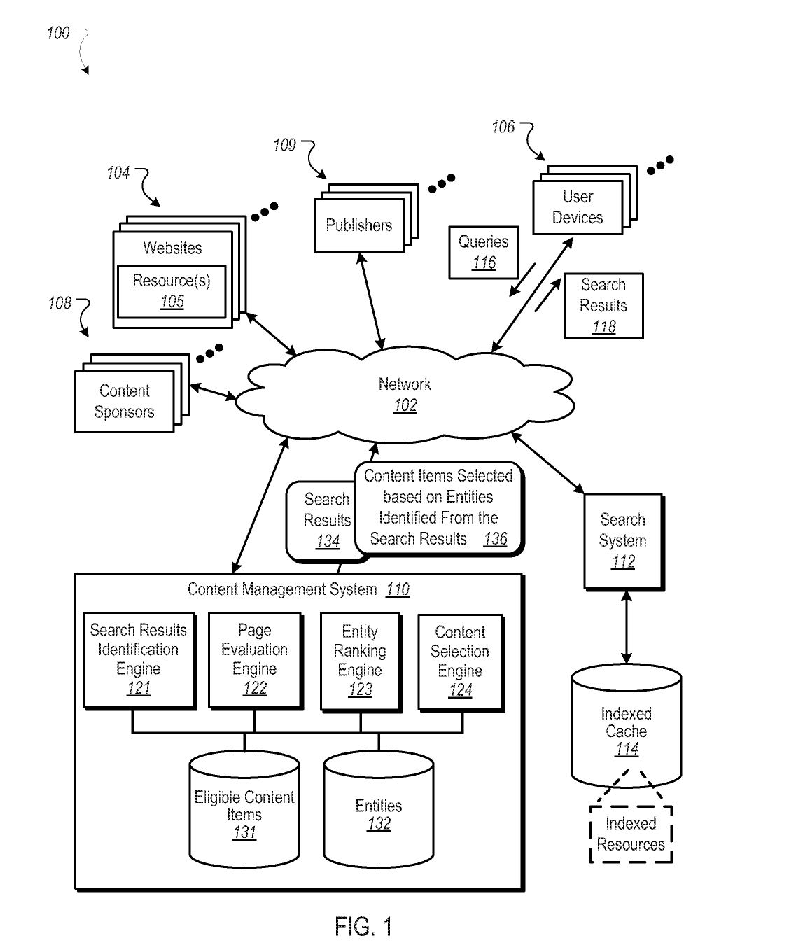

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

In some implementations, in response to a search query 116, the content management system 110 (or another system) can provide search results 134 and one or more content items 136 that are determined based, at least in part, on entities associated with the search results 134. The content item(s) 136 can be, for example, one or more advertisements associated with entities identified from pages associated with a number of top ones of the search results 134.

The environment 100 can include plural data stores, which can be stored locally with the content management system 110, stored somewhere else and accessible using the network 102, generated as needed from various data sources, or some combination thereof A data store of eligible content items 131, for example, can include content items that can be provided in response to a request for content. For example, the content items can be advertisements that can be provided to fill a content item slot on a page showing search results. The eligible content items 131 can also include content items that can be provided as search results.

A data store of entities 132, for example, can include identifiers, definitions and/or other information about entities, such as entities associated with products, product categories, product manufacturers, specific models of products, verticals, services, service categories or user activities. Other entities, for example, can include specific books, authors, films, songs, artists, etc., or generic concepts that may be more semantic in nature (e.g., friendship, family, values, well-being, or other general concepts). Entities 132 can also include definitional information for use in identifying entities, e.g., including keywords or other information associated with each entity that can be used to identify prominent entities associated with a resource 105 (e.g., a web page). Entities and entity definitions can be hierarchical, meaning that one entity (e.g., cameras) can include other sub-entities (e.g., land cameras and digital cameras). Other relationships among entities can exist. In some implementations, entities that may be ambiguous, such as orange the color and orange the fruit, can be disambiguated using various other signals.

The content management system 110 can include plural engines. A search results identification engine 121, for example, can identify search results for a received search query, including identifying a number of top search results (e.g., 30). For example, the search results can be identified based at least in part on terms and/or phrases included in the search query.

A page evaluation engine 122, for example, can evaluate web pages associated with each of the top search results to identify prominent entities that describe content represented by referenced page (e.g., the web page referenced by the search result). The page evaluation engine 122 can also create a list of prominent entities associated with the web pages.

An entity ranking engine 123, for example, can rank the entities (e.g., using various criteria such as popularity) and can use the list of ranked entities to determine selection criteria. For example, determining the selection criteria can include determining a weighted list of entities from the list of prominent entities for use in selecting content.

A content selection engine 124 can determine one or more content items to deliver along with the search results using the selection criteria. The content selection engine 124 can select the content items, for example, from the eligible content items 131 using selection criteria, including using the weighted list of entities.

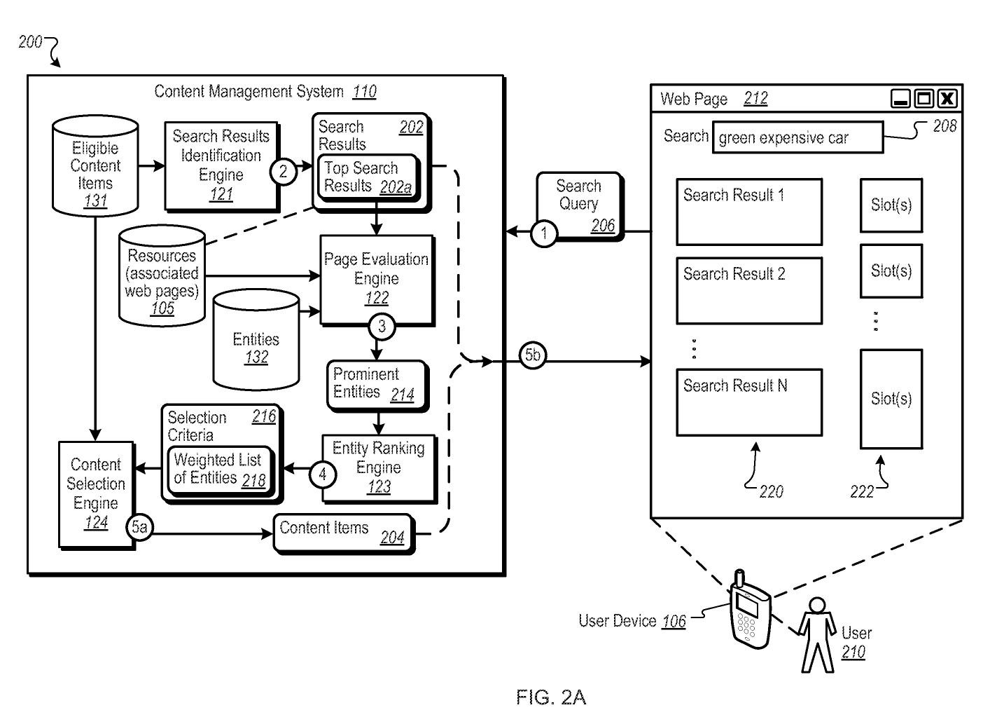

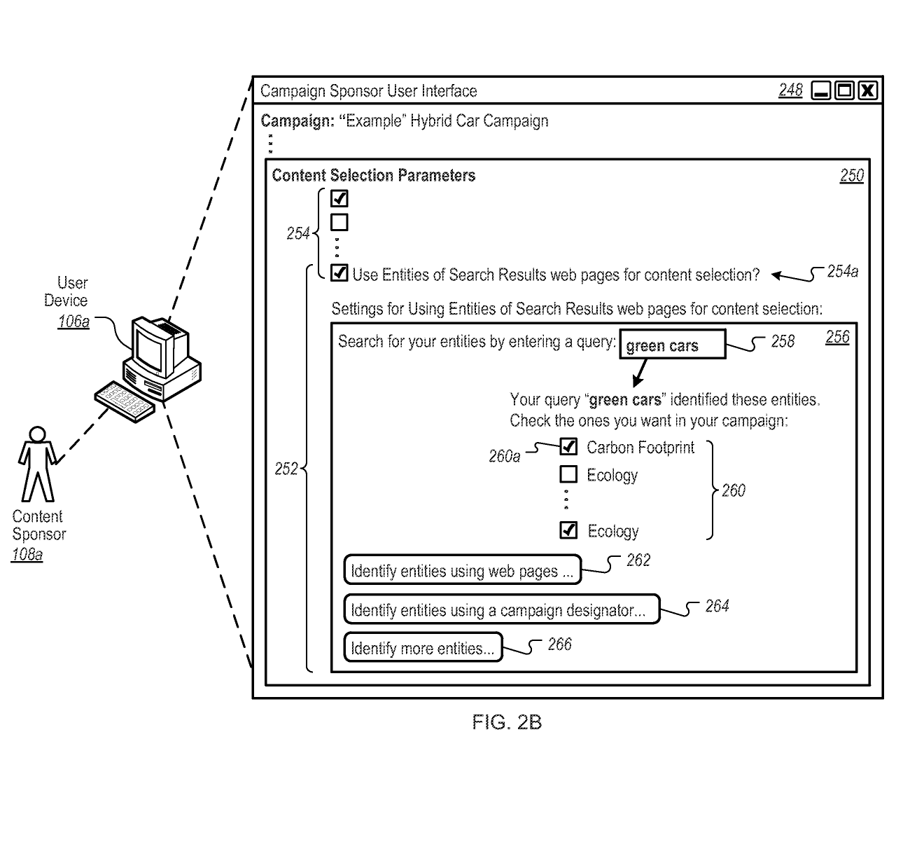

In some implementations, content sponsors 108 can be provided with an interface for defining selection criteria associated with the selection of their content items for presentation to users. One possible selection criteria that can be specified can be an entity or a group of entities. For example, content sponsors 108 can specify that their content items can be selected on the basis of matching entities associated with web pages corresponding to search results entries, as described in detail below with respect to FIG. 2B. The use of entities in the selection and presentation of content items is discussed in greater detail below with respect to FIG. 2A.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. In some implementations, the search results 118 include the content itself, such as a map, or an answer, such as in response to a query for a store's products, phone number, address or hours of operation. In some implementations, the content management system 110 can generate search results 118 using information (e.g., identified resources) received from the search system 112. An example search result 118 can include a webpage title, a snippet of text or a portion of an image extracted from the webpage, and the URL of the webpage. Search results pages can also include one or more slots in which other content items (e.g., ads) can be presented. In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In some implementations, the selection of the eligible content items can further depend on user signals, such as demographic signals and behavioral signals.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection or other interaction with) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as republishing or sharing the content item. Other actions that constitute a conversion can also be used.

In some implementations, conversions may be more likely to occur when a content item is selected and presented that matches one or more entities, for example, associated with resources (e.g., web pages) corresponding to search results. For example, the user may be more likely to interact with an advertisement associated with an entity, e.g., if the entity provides what the user was looking for by entering the query.

FIG. 2A shows an example system 200 for selecting content items based on entities determined from search results. For example, the content management system 110 can provide search results 202 and content items 204 to the user device 106 in response to a received search query 206. The search results 202 can be selected based on keywords in the search query 206 and/or other criteria. The content items 204 can be identified based on their association with entities that are identified from the search results 202. A more detailed example follows using an example sequence of stages 1-5b.

At stage 1, for example, the content management system 110 can receive a search query 206 that includes one or more terms and/or phrases. The search query 206, for example, can be “green expensive car” provided in a search query control 208 by a user 210 using a browser on a web page 212.

At stage 2, for example, the search results identification engine 121 can identify search results 202 for the search query 206, including identifying a number of top search results 202a. Identifying the search results 202, for example, can be based at least in part on the one or more terms or phrases (e.g., green, expensive, car) included in the search query 206. The number of top search results 202a, for example, can be set at a predetermined number (e.g., 30). For example, the predetermined number can be based on historical experience regarding a number of search results that users are likely to view. In some implementations, the predetermined number can vary depending on whether a user is using a mobile device or a non-mobile device and/or the type of device the user is using, e.g., having different display capabilities.

At stage 3, for example, the page evaluation engine 122 can evaluate a web page, associated with each of the number of top search results 206a, to identify prominent entities that describe content represented by the web page. For example, evaluating the web pages can include creating a list of prominent entities 214. Entities, for example, can include any one of a product, a product category, a product manufacturer, a specific model of a product, a vertical, a service, a service category, a user intent or interest associated with a product or a service, and a user activity. In the current example, based on the terms and/or phrases in the search query 206 “green expensive car,” the list of prominent entities 214 determined by the page evaluation engine 122 can include “Example Hybrid,” e.g., a manufacturer of a “green” (environmental) car. In some implementations, while several entities 132 may be determined to be associated with the top search results 202a, only prominent entities are retained in the list of prominent entities 214. Prominence can be determined in various ways, such as by ranking, number of occurrences, or other factors. In some implementations, the prominence determined for a particular entity can depend, for example, on the placement of the entity term on a web page. For example, an entity name appearing in the header/title (e.g., “How to Reduce Your Carbon Footprint”) or image caption of a webpage can have a higher prominence than one appearing only in the text of the web page.

At stage 4, for example, the entity ranking engine 123 can determine selection criteria 216 using the list of prominent entities 214. Determining the selection criteria 216 can include, for example, ranking the entities in the list of prominent entities 214 based at least in part on the importance of a given entity to a respective source page (e.g., a resources 105) and a page rank of the source page. For example, determining the selection criteria 216 can include determining a weighted list of entities 218 to use as selection criteria for selecting content.

At stage 5a, for example, the content selection engine 124 can determine one or more content items 204 to deliver along with the search results 202. The content selection engine 124 can select the content items 204, for example, from the eligible content items 131 based at least in part on the selection criteria 216, including the weighted list of entities 218. The selection can also depend on how each respective eligible content item matches one or more of the weighted list of entities 218 (e.g., “Example Hybrid”). In some implementations, the selection process can be similar to the selection from among eligible content items, as described above with reference to FIG. 1. Other selection methods can be used.

At stage 5b, for example, the content management system 110 can provide the search results 202 and the content items 204 to the user device 106 in response to the search query 206. The search results 202, e.g., can be presented to the user 210 as search results 220. The content items 204, e.g., advertisements, can be presented in content item slots 222 (e.g., ad slots). In some implementations, content items 204 can be presented in other locations on the web page 212, including for example, as content items included in, or displayed with, any of the search results 220. For example, a sponsored content item can be shown next to a search result, e.g., when the content sponsor (e.g., advertiser) has provided selection criteria that match the result entities for a given search result, the content sponsor is the owner of the search result landing page, and/or the content sponsor has provided additional information to augment the search result.

FIG. 2B shows an example content sponsor user interface 248 for specifying the use of search results-related entities in selecting content. For example, the content sponsor user interface 248 can be presented to a content sponsor 108a who is using a user device 106a for defining a campaign, e.g., an advertisement campaign for an “Example” hybrid car. In some implementations, the content sponsor user interface 248 can include, for example, a selection parameters area 250, among other types of areas typically included in content sponsor interfaces. Some implementations of the selection parameters area 250 can include one or more controls 252 that can be used, for example, by the content sponsor 108a for providing input related to selection criteria for use in a campaign.

In some implementations, the content sponsor 108a can make multiple different selections on the content sponsor user interface 248. For example, controls 254 can include an entity-related control 254a for specifying the use of entities (e.g., entities of web pages associated with search results), such as for selecting content (e.g., advertisements of the content sponsor 108a). If the control 254a is selected, for example, an entities-related area 256 can be presented.

In some implementations, the entities-related area 256 can include a search control 258, for example, for user specification of a search query (e.g., “green cars”) to be used as initial criteria for identifying entities. Based on input from the content sponsor 108a in the search control 258, for example, the content sponsor user interface 248 can identify and present controls 260 associated with entities that satisfy the search query. The content sponsor 108a can select the control 260a, for example, to specify that the entity “carbon footprint” is to be used in selecting content in the campaign. Referring also to FIG. 2A, for example, the selection of the control 260a for the entity “carbon footprint” can facilitate the selection of the content items 204 to be presented with the search results 202. For example, an advertisement related to the entity “carbon footprint” might be selected that might not be selected otherwise (e.g., without using entities).

In some implementations, the content sponsor user interface 248 can include a control 262 for specifying web pages for use in identifying entities. For example, when the content sponsor 108a selects the control 262, another screen or interface can appear in which the content sponsor can use one or more controls to identify one or more web pages. The content sponsor user interface 248 can use the identified web pages to identify related entities, e.g., based on content on the web pages.

In some implementations, the content sponsor user interface 248 can include a control 264 for specifying a campaign designator that identifies a campaign associated with the content sponsor 108a. For example, using the control 264, the content sponsor 108a can enter an identifier that identifies a campaign. Using the identifier, the content sponsor user interface 248 can determine a list of search queries that have, in the past, matched the identified campaign. Using the search queries, the content sponsor user interface 248 can determine associated search results. One or more entities can be determined from the determined search results, and the one or more entities can be stored with the campaign as selection criteria for subsequent use in selecting content.

Other ways of specifying and/or selecting entities are possible. For example, a control 266, when selected by the content sponsor 108a, can provide access to additional controls for selecting entities in other ways. In some implementations, other ways of selecting entities can include, for example, keying in the names of entities, selecting entities from a list, selecting from entities used in the past by the content sponsor 108a, and/or other ways.

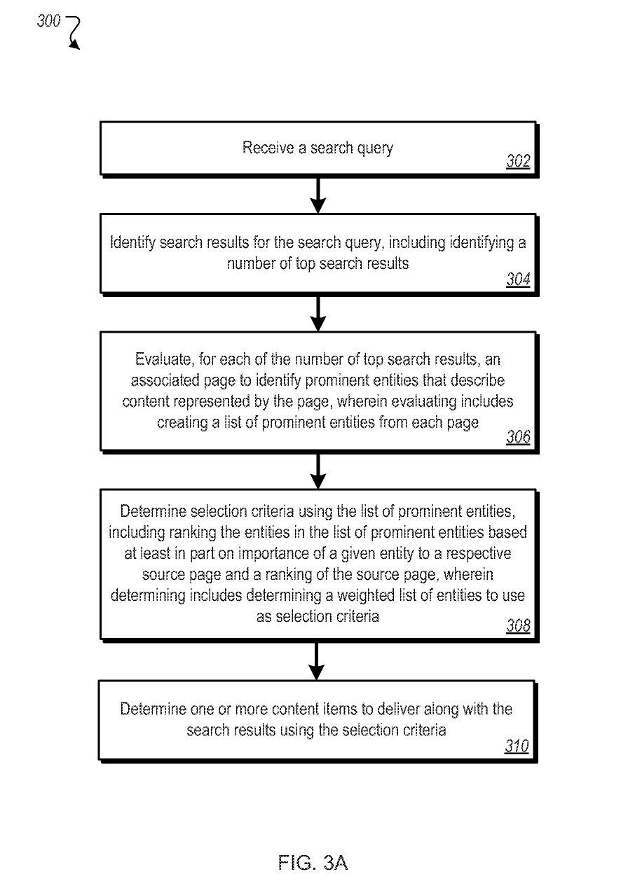

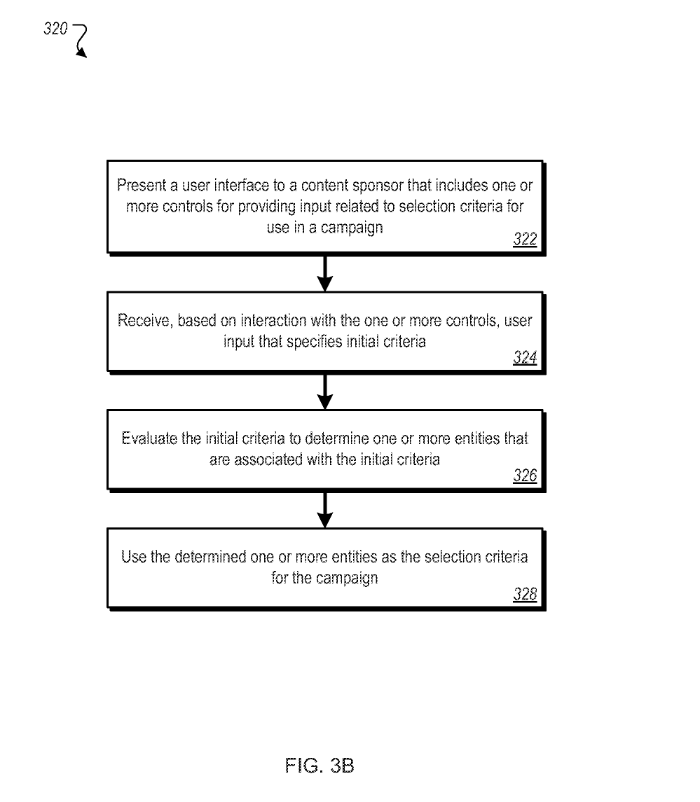

FIG. 3A is a flowchart of an example process 300 for selecting content items based on entities determined from search results. In some implementations, the content management system 110 can perform stages of the process 300 using instructions that are executed by one or more processors. FIGS. 1-2B are used to provide example structures for performing the stages of the process 300.

A search query is received (302). For example, the content management system 110 can receive the search query 206 from the user device 106. The search query 206 can include, for example, terms/phrases “green expensive car” provided by the user 210 in the search query control 208. The user's purpose of the search query 206, for example, can be to cause the generation and receipt of search results 202 in response to the query (e.g., matching terms in “green expensive car”).

Search results are identified for the search query, including identifying a number of top search results (304). As an example, the search results identification engine 121 can use terms in the search query 206 to identify the search results 202 that include search results related to expensive green cars (e.g., high-end hybrids). In addition, the search results identification engine 121 can identify the top search results 202a, e.g., the top 30 of the search results 202.

For each of the number of top search results, an associated page is evaluated to identify prominent entities that describe content represented by the page, wherein evaluating includes creating a list of prominent entities from each page (306). For example, the page evaluation engine 122 can evaluate resources 105 (e.g., web pages) associated with each of the top search results 202a. The evaluating can include evaluating the web pages and creating a list of prominent entities 214, e.g., identifying the prominent entities that describe content represented by the web pages.

In some implementations, an entity can be a concept mentioned on a web page. For example, the search query that includes “green expensive car” can lead to a search result having a corresponding web page related to reducing one's carbon footprint. In this example, the concept “carbon footprint” may be mentioned multiple times on that particular web page as well as on web pages associated with other search results.

Selection criteria are determined using the list of prominent entities, including ranking the entities in the list of prominent entities based at least in part on an importance of a given entity to a respective source page and a ranking of the source page, wherein determining includes determining a weighted list of entities to use as selection criteria (308). As an example, the entity ranking engine 123 can determine the selection criteria 216 using information associated with the list of prominent entities 214. The entity ranking engine 123 can also rank the entities in the list of prominent entities 214 based at least in part on an importance of a given entity to a respective resource 105 and a ranking of the source page. For example, the selection criteria 216 can include a weighted list of entities 218 to use as selection criteria for selecting content (e.g., advertisements).

In some implementations, at least one entity in the weighted list of entities can represent an answer to the search query. For example, the user 210 may not know or remember the exact term corresponding to a concept that the user 210 is trying to remember, e.g., “carbon footprint.” However, by entering a few query terms that the user 210 believes are related to the concept, the entity “carbon footprint” can be identified from among the web pages associated with the search results provided in response to the query. In this example, the weighted list of entities 218 can include the entity that answers the user's question.

In some implementations, the ranking can be based at least in part on a page rank of the source page in the search results. For example, while each source page can result in the identification of multiple entities, the rank that any one entity is assigned in the weighted list of entities 218 can depend on the source page (and its page rank) from which the entity originated. For example, a higher rank can occur for Entity X determined from the web page of the first search result as opposed to the same or a different entity determined from the 30^{th} search result. Similarly, an entity will receive a higher rank based on the number of times that the entity is mentioned on a particular source page (e.g., web page).

In some implementations, ranking can be based at least in part on a popularity of the source page. As an example, source pages that get viewed by more users can result in corresponding entities being ranked higher than entities associated with source pages getting viewed by fewer users, all other things being equal.

In some implementations, evaluating a page to identify prominent entities can include using other signals to disambiguate ambiguous entities. For example, a user's recent past queries (e.g., including a query with the term “fruit”) can be used to determine an intent of a user's current query containing “orange” and to conclude, for the determined entity, that the entity is related to orange the fruit and not orange the color.

Using the selection criteria, one or more content items are determined to be delivered along with the search results (310). As an example, the content selection engine 124 can use the selection criteria 216 to determine the one or more content items 204 to deliver along with the search results 202. The content selection engine 124 can select the content items 204, for example, from the eligible content items 131 based at least in part on the selection criteria 216, including the weighted list of entities 218.

The content management system 110, for example, can provide the search results 202 and the content items 204 to the user device 106 in response to the search query 206. The search results 202, e.g., can be presented to the user 210 as search results 220. The content items 204, e.g., advertisements, can be presented in content item slots 222 (e.g., ad slots). In some implementations, the content items 204 can be presented in other locations on the web page 212, including for example, as content items included in, or displayed with, any of the search results 220.

FIG. 3B is a flowchart of an example process 320 for specifying entity-related parameters for use in a campaign. In some implementations, the content management system 110 can perform stages of the process 320 using instructions that are executed by one or more processors. FIGS. 1-2B are used to provide example structures for performing the stages of the process 320.

A user interface is presented to a content sponsor that includes one or more controls for providing input related to selection criteria for use in a campaign (322). For example, referring to FIG. 2B, the content sponsor user interface 248 can be presented to the content sponsor 108a for specifying the use of search results-related entities in selecting content.

Based on interaction with the one or more controls, user input is received that specifies initial criteria (324). As an example, the content sponsor 108a can select the entity-related control 254a to indicate a preference for specifying the use of entities (e.g., entities of webpages associated with search results) for selecting content (e.g., advertisements of the content sponsor 108a). In some implementations, when the control 254a is selected, for example, the entities-related area 256 can be presented, in which the content sponsor 108a can enter a search query (e.g., “green cars”) to be used as initial criteria for identifying entities.

The initial criteria are evaluated to determine one or more entities that are associated with the initial criteria (326). For example, based on the search query entered by the content sponsor 108a in the search control 258, the content sponsor user interface 248 can identify entities satisfying the query and present controls 260 associated with the identified entities. In some implementations, evaluating the initial criteria (e.g., the search query) can include determining search results responsive to the search query, determining entities based on the determined search results, and using the determined entities as the one or more entities. For example, the content sponsor user interface 248 can identify search results associated the search query (e.g., “green cars”), identify the web pages associated with the search results, and identify entities (e.g., including carbon footprint) associated with the search results. The content sponsor 108a can select the control 260a, for example, to specify that the entity “carbon footprint” is to be used in selecting content in the campaign. Entities, for example, can include concepts mentioned on a web page, or concepts related to a web page.

In some implementations, the initial criteria can include the designation of one or more web pages, wherein evaluating the initial criteria further includes evaluating the one or more web pages, including determining entities associated with the one or more web pages, and using the determined entities as the one or more entities. For example, the content sponsor 108a can use the control 262 for specifying web pages (e.g., by identifying associated URLs or in other ways) for use in identifying entities, as described above.

In some implementations, the one or more web pages can be target web pages that the content sponsor designates as being a type of page that, when presented as a search result, would represent a desirable opportunity to present a content item associated with the campaign from the perspective of the content sponsor. For example, using the control 262 and subsequent controls, the content sponsor 108a can identify web pages that are controlled by the content sponsor 108a and/or are landing pages associated with the content sponsor's campaign. These web pages, for example, can provide the content sponsor 108a with opportunities to present content items (e.g., advertisements) to a user.

In some implementations, the initial input can be a campaign designator that identifies a campaign associated with the content sponsor, and evaluating the initial criteria can further include determining a list of search queries that have matched the identified campaign, determining search results associated with one or more of the search queries, determining entities based on the determined search results, and using the determined entities as the one or more entities. For example, the content sponsor user interface 248 can include the control 264, as described above. The content sponsor 108a can use the control 264, for example, to identify a campaign designator for use in determining a list of search queries that have, in the past, matched the identified campaign. The content sponsor user interface 248 can determine associated search results using the search queries. One or more entities determined from the determined search results can be stored with the campaign as selection criteria.

Other ways of specifying and/or selecting entities are possible. For example, a control 266, when selected by the content sponsor 108a, can provide access to addition controls for selecting entities in other ways. In some implementations, other ways of selecting entities can include, for example, searching for entities in various other ways, keying in the names of entities, selecting entities from a list, selecting from entities used in the past by the content sponsor 108a, providing long text that can be searched and analyzed to identify entities, and/or other ways.

The determined one or more entities are used as the selection criteria for the campaign (328). For example, referring also to FIG. 2A, the selection of the control 260a for the entity “carbon footprint” can facilitate the selection of the content items 204 (e.g., related to the entity “carbon footprint”) to be presented with the search results 202.

In some implementations, the method 320 can further include receiving, from the user, weights associated with entities chosen for selecting content. For example, using additional controls not shown in the content sponsor user interface 248, the content sponsor 108a can designate Entities A, B and C as having high, medium and low weights, respectively. Other ways of designating weights or the importance of individual entities are possible.

In some implementations, content sponsors can specify that certain identified entities are not to be used as selection criteria (or otherwise should be considered to be of the form of negative content selection criteria). For example, the content sponsor 108a can identify one or more entities to include in a negative entity list. The negative entity list can be used to determine when content items (e.g., advertisements) associated with a given campaign are not to be selected. The content selection engine 124, for example, can use negative entity list information for campaigns so as not to include certain content items in the content items 204 (e.g., the eligible content items). For example, a content sponsor may wish to not have their content (e.g., the content associated with a specific campaign) presented when one or more particular entities are included in top search results (e.g., the prominent entities 214). Other ways of using entities as negative selection criteria are possible.

In some implementations, content sponsors can specify certain entity relationships as selection criteria. Entity relationships can define not only the presence of two specific entities, but a relationship between the respective entities. As an example, the content sponsor 108a can include, as selection criteria, “select content for all queries that contain any entity X such that X is linked with a ‘building-type’ relationship to the ‘hotel’ entity.” In another example, combinations of relationships can be used, e.g., to require that entity X “is-contained-in-geographic-locations” Y (e.g., in a city, region, state, or country). In another example, content sponsors can select entities from a list of entities that have been generated as meeting certain entity relationships, e.g., all hotels in a specified location (e.g., Berlin). Other ways of using entity relationships are possible.

In some implementations, content sponsors 108 can provide content presentation criteria that can cause their content items (e.g., advertisements) to be promoted (e.g., based on higher bids) on the basis of entities. For example, an advertisement for Brand X can be associated with the entity Brand X that is identified from web pages of the search results associated with a user's query, as described above. If the advertisement is anticipated to appear below the fold (or not on the first page of search results), for example, the advertisement can be promoted to appear above the fold (or on the first page of search results), e.g., based on content sponsor settings for increasing bid amounts based their selection criteria (e.g., based on a specification of one or more related entities that are satisfied by the content that is above the fold or included on the first page of search results).

In some implementations, entities can be used as bid modifiers in auctions for selecting content. For example, when a specific entity (e.g., one of the prominent entities 214) is associated with an eligible content item, the bid for the eligible content item can be increased, decreased or otherwise modified by a certain amount or percentage, e.g., based on settings of the associated campaign.

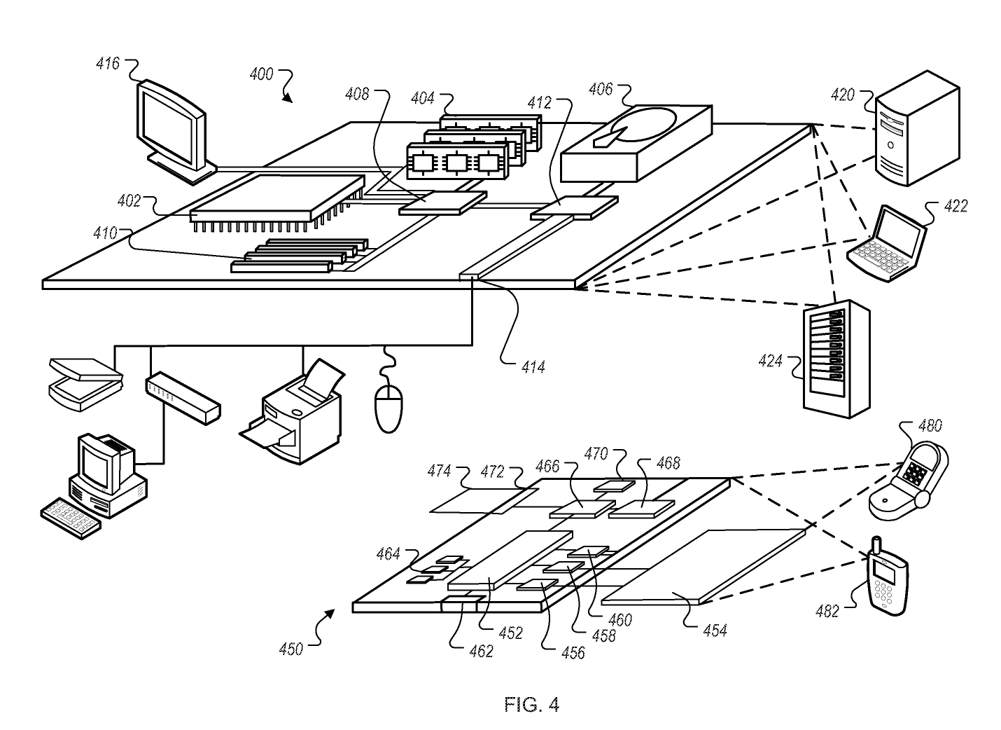

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a search query;
identifying search results for the search query including identifying a number of top search results;
evaluating, for each of the number of top search results, an associated page to identify prominent entities that describe content represented by the page, wherein evaluating includes creating a list of prominent entities from each page;
determining selection criteria using the list of prominent entities including ranking the entities in the list of prominent entities based at least in part on importance of a given entity to a respective source page and a ranking of the source page, wherein determining includes determining a weighted list of entities to use as selection criteria; and
determining one or more content items to deliver along with the search results using the selection criteria.

2. The method of claim 1 wherein at least one entity in the weighted list of entities represents an answer to the search query.

3. The method of claim 1 wherein the ranking is based at least in part on a page rank of the source page in the search results.

4. The method of claim 1 wherein the ranking is based at least in part on a popularity of the source page.

5. The method of claim 1 wherein an entity is a concept mentioned on a web page.

6. The method of claim 1 wherein identifying prominent entities includes annotating the page with entities including identifying entities on the page, disambiguating entities using other entities on the page and scoring the entities for the page to identify the prominent entities.

7. The method of claim 1 further comprising:
receiving, from content sponsors, campaign selection criteria for a given campaign, the campaign having an associated content item, wherein the campaign selection criteria are of the form of a list of entities to use when determining when to serve the content item;
wherein determining one or more content items includes determining campaigns that have campaign selection criteria that match the selection criteria and serving one or more content items from the determined campaigns as the one or more content items.

8. A computer-implemented method comprising:
presenting a user interface to a content sponsor that includes one or more controls for providing input related to selection criteria for use in a campaign;
receiving, based on interaction with the one or more controls, user input that specifies initial criteria;
evaluating the initial criteria to determine one or more entities that are associated with the initial criteria; and
using the determined one or more entities as the selection criteria for the campaign.

9. The method of claim 8 wherein the initial criteria is a search query, and wherein evaluating the initial criteria further includes determining search results responsive to the search query, determining entities based on the determined search results and using the determined entities as the one or more entities.

10. The method of claim 8 wherein the initial criteria include the designation of one or more web pages, wherein evaluating the initial criteria further includes evaluating the one or more web pages including determining entities associated with the one or more web pages and using the determined entities as the one or more entities.

11. The method of claim 10 wherein the one or more web pages are target web pages that the content sponsor designates as being a type of page that, when presented as a search result, would represent a desirable opportunity to present a content item associated with the campaign from the perspective of the content sponsor.

12. The method of claim 11 wherein the one or more pages are controlled by the content sponsor.

13. The method of claim 11 wherein the one or more pages are landing pages associated with the campaign.

14. The method of claim 8 wherein the initial input is a campaign designator that identifies a campaign associated with the content sponsor, and wherein evaluating the initial criteria further includes determining a list of search queries that have matched the identified campaign, determining search results associated with one or more of the search queries, determining entities based on the determined search results, and using the determined entities as the one or more entities.

15. The method of claim 8 wherein an entity is a concept mentioned on a web page.

16. A system comprising:
one or more processors; and
one or more memory elements including instructions that, when executed, cause the one or more processors to:
receive a search query;
identify search results for the search query including identifying a number of top search results;
evaluate, for each of the number of top search results, an associated page to identify prominent entities that describe content represented by the page, wherein evaluating includes creating a list of prominent entities from each page;
determine selection criteria using the list of prominent entities including ranking the entities in the list of prominent entities based at least in part on importance of a given entity to a respective source page and a ranking of the source page, wherein determining includes determining a weighted list of entities to use as selection criteria; and
determine one or more content items to deliver along with the search results using the selection criteria.

17. A computer program product embodied in a non-transitive computer-readable medium including instructions, that when executed, cause one or more processors to:
receive a search query;
identify search results for the search query including identifying a number of top search results;
evaluate, for each of the number of top search results, an associated page to identify prominent entities that describe content represented by the page, wherein evaluating includes creating a list of prominent entities from each page;
determine selection criteria using the list of prominent entities including ranking the entities in the list of prominent entities based at least in part on importance of a given entity to a respective source page and a ranking of the source page, wherein determining includes determining a weighted list of entities to use as selection criteria; and
determine one or more content items to deliver along with the search results using the selection criteria.

18. A system comprising:
one or more processors; and
one or more memory elements including instructions that, when executed, cause the one or more processors to:
present a user interface to a content sponsor that includes one or more controls for providing input related to selection criteria for use in a campaign;
receive, based on interaction with the one or more controls, user input that specifies initial criteria;
evaluate the initial criteria to determine one or more entities that are associated with the initial criteria; and
use the determined one or more entities as the selection criteria for the campaign.

19. A computer program product embodied in a non-transitive computer-readable medium including instructions, that when executed, cause one or more processors to:
present a user interface to a content sponsor that includes one or more controls for providing input related to selection criteria for use in a campaign;
receive, based on interaction with the one or more controls, user input that specifies initial criteria;
evaluate the initial criteria to determine one or more entities that are associated with the initial criteria; and
use the determined one or more entities as the selection criteria for the campaign.
